(19) United States
(12) Patent Application Publication
(10) Pub. No.: US 2020/0196565 A1
(43) Pub. Date: Jun. 25, 2020

(54) IMPROVED MODULAR FENCING STORAGE AND HANDLING DEVICE

(71) Applicant: MUNRO ENGINEERS PTY. LTD., Ballarat, Victoria (AU)

(72) Inventors: Christopher Elliott, Maribyrnong (AU); Brad Elliott, Athlone (AU); Grant Elliott, Drouin (AU)

(73) Assignee: MUNRO ENGINEERS PTY. LTD., Ballarat (AU)

(21) Appl. No.: 16/608,844

(22) PCT Filed: Apr. 27, 2018
(86) PCT No.: PCT/AU2018/000063

§ 371 Date: Oct. 27, 2019

(30) Foreign Application Priority Data
Apr. 27, 2017 (AU) 2017901533

(51) Int. Cl. A01K 3/00; E04H 17/10

(52) U.S. Cl. CPC A01K 3/005; E04H 17/266; E04H 17/10

(57) ABSTRACT

A modular fencing storage and handling apparatus includes at least one interchangeable automated reel cradle module having a cradle for the storage and handling of a fence wire reel, a powered driving mechanism to control the automated winding of a fence wire onto the fence wire reel and a layering device, which allows the fence wire to be layered evenly across the fence wire reel as it is being fed onto the fence wire reel.

### FIELD OF THE INVENTION

The present invention relates to fencing and fencing accessories. In particular, but not exclusively, the present invention relates to an improved modular fencing storage and handling device. However, it will be appreciated that the present invention has broader application and is not limited to that particular use.

### BACKGROUND TO THE INVENTION

Electric fences are widely used across a broad range of applications, which can include being used to split paddocks, electric fence across hay sheds, as a wing into yards or side paddocks, as a temporary gate, as a temporary fence to protect planting or hay, or as a portable temporary fence for strip grazing and horse fence for yards. Typically, one or more strands of wire, synthetic tape or cord are mounted on metal or plastic posts with stakes at the bottom, designed to be driven into the ground.

Rapid laying-out and removal of multiple-strand temporary electric fencing over a large area may be done using a set of reels mounted on a tractor or all-terrain vehicle. ATVs, tray-backs or even tractors, can be used to make the daily tasks of relocating fencing more efficient by carrying multiple fence reels and posts. While many common injuries can be prevented with the use of proper protective equipment, there are a number of dangers associated with riding such vehicles single-handed while holding onto reels and posts, which can lead to a number of farming accidents. Hence, there is a need for a solution which addresses these current problems.

In this specification, the terms “comprises”, “comprising” or similar terms are intended to mean a non-exclusive inclusion, such that an improved modular fencing storage and handling device that comprises a list of elements does not include those elements solely, but may well include other elements not listed.

### OBJECT OF THE INVENTION

It is an object of the present invention to provide an improved modular fencing storage and handling device, that addresses or at least ameliorates one or more of the aforementioned problems of the prior art and/or provides consumers with a useful or commercial choice.

### SUMMARY OF THE INVENTION

Generally, embodiments of the present invention relate to an improved modular fencing storage and handling device.

According to one aspect, although not necessarily the broadest aspect, the present invention resides in a modular fencing storage and handling device comprising:

at least one interchangeable automated reel cradle module comprising:
a cradle for the storage and handling of a fence wire reel;
a powered driving mechanism to control the automated winding of a fence wire onto the fence wire reel; and
a layering means which allows the fence wire to be layered evenly across the fence wire reel as it is being fed onto the fence wire reel.

Preferably, the automated reel cradle module is operable with any existing fence wire reel.

Preferably, the driving mechanism comprises a motor.

Preferably, one or more rubber coated drive rollers of the driving mechanism are mounted within the base of the automated reel cradle module and are driven by a pulley.

Preferably, the torque is controlled electronically to prevent damage from overload.

Preferably, the layering means is in the form of a wire feed guide.

Preferably, the wire feed guide is driven by the motor through a gearbox within the base of the automated reel cradle module.

Preferably, the wire feed guide comprises a guide arm having a guide arm and a retaining means in the form of a loop or guide for receiving the fence wire and allowing it to be held and fed therethrough onto the fence reel via the wire feed guide.

Preferably, the modular fencing storage and handling device further comprises at least one interchangeable storage module removably connected thereto to store a fencing component required for the installation of temporary fencing including one or more of the following: an automated reel cradle module, a non-automated reel cradle module, a toolbox module and/or a post rack module.

According to another aspect, although not necessarily the broadest aspect, the present invention resides in an automated reel cradle module comprising:

a cradle for the storage and handling of a fence wire reel;

a powered driving mechanism to control the automated winding of a fence wire onto the fence wire reel; and

a layering means which allows the fence wire to be layered evenly across the fence wire reel as it is being fed onto the fence wire reel.

Preferably, the automated reel cradle module is operable with any existing fence wire reel.

Preferably, the driving mechanism comprises a motor.

Preferably, one or more rubber coated drive rollers of the driving mechanism are mounted within the base of the automated reel cradle module and are driven by a pulley.

Preferably, the torque is controlled electronically to prevent damage from overload.

Preferably, the layering means is in the form of a wire feed guide.

Preferably, the wire feed guide is driven by the motor through a gearbox within the base of the automated reel cradle module.

Preferably, the wire feed guide comprises a guide arm having a guide arm and a retaining means in the form of a loop or guide for receiving the fence wire and allowing it to be held and fed therethrough onto the fence reel via the wire feed guide.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 shows a front perspective view of an improved modular fencing storage and handling device according to embodiments of the present invention having an automated reel cradle module and a non-automated reel cradle module;

FIG. 2 shows a rear perspective view of an improved modular fencing storage and handling device according to embodiments of the present invention having an automated reel cradle module and a non-automated reel cradle module;

FIG. 3a shows a side cross-sectional view of the automated reel cradle module of the modular fencing storage and handling device of FIG. 1, wherein a spring-loaded locking mechanism is in an unlocked position;

FIG. 3b shows a side cross-sectional view of the automated reel cradle module of the modular fencing storage and handling device of FIG. 1, illustrating a powered drive mechanism;

FIG. 4a shows a side cross-sectional view of a first side of the automated reel cradle module of the modular fencing storage and handling device of FIG. 1; and

FIG. 4b shows a side view of a second side of the automated reel cradle module of the modular fencing storage and handling device of FIG. 1.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

Embodiments of the present invention will be described with reference to an improved modular fencing storage and handling device. For convenience sake, the device will be described herein as an improved modular storage and handling device for electric fencing which provides storage for temporary fence posts, portable electric fence wire reels and other fencing components which can be carried by a suitable vehicle including, but not limited to, all-terrain vehicles. However, it should be appreciated that embodiments of the present invention can be modified to suit other suitable applications and/or vehicles for carrying the device. It will be appreciated that variations may need to be made as required.

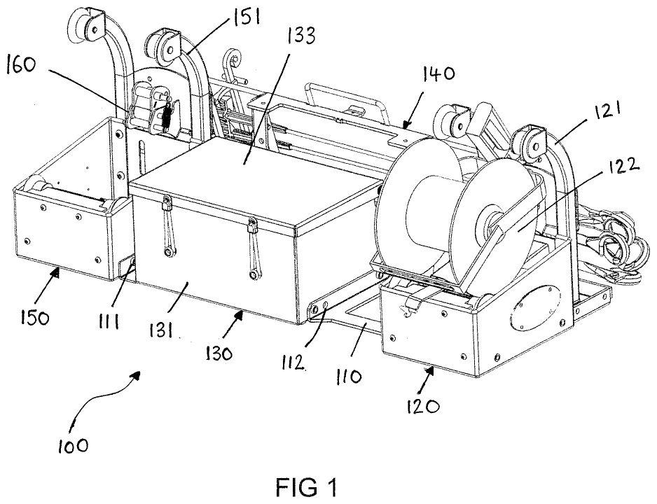

Referring to FIG. 1, the improved modular fencing storage and handling device 100 is provided in accordance with embodiments of the present invention. According to some embodiments, the improved modular fencing storage and handling device 100 comprises at least one interchangeable module 120, 130, 140, 150 which is adapted to store a fencing component required for the installation of temporary electric fencing. The modular nature of the device 100 provides the ability to add to, and change, the device to allow for different configurations to suit different needs and requirements. The modules are easily bolted together allowing a user to choose the size and storage capacity and configuration to suit their needs.

Referring to FIG. 1, the improved modular fencing storage and handling device 100 comprises at least one interchangeable module which can be removably connected one or more other adjacent interchangeable module(s). Preferably, the modules 120, 130, 140, 150 are connected to one another via at least one fastening member such as a bolt 111 or the like which is received through a corresponding aperture 112 provided on a base of the modules 120, 130, 140, 150. However, it is envisaged that any other suitable fastening means which enables quick and easy assembly and disassembly may also be adopted.

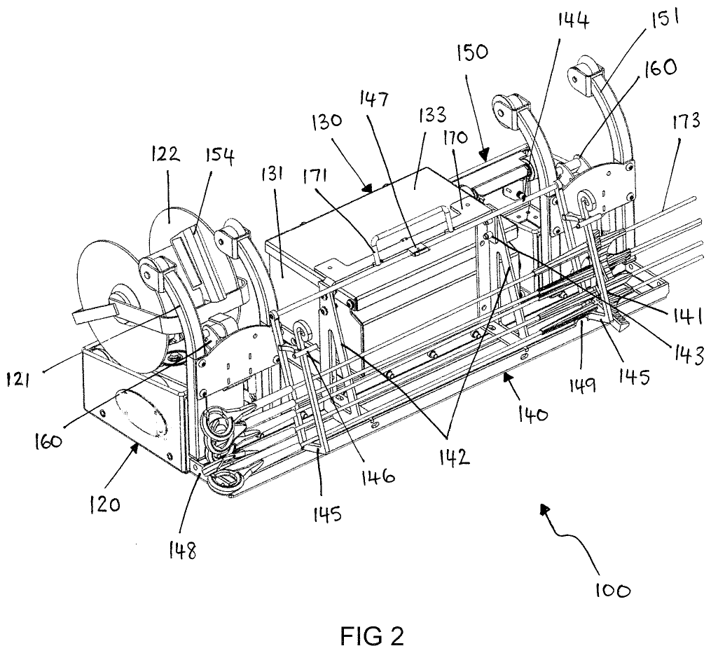

As illustrated in FIGS. 1 and 2, the improved modular fencing storage and handling device 100 may comprise at least one non-automated reel cradle module 150 for the storage and handling of a fence wire reel including, but not limited to, an electric fence wire reel. The fence wire reel can be any commercially available reel which can easily be retrofitted into the present invention. It will be acknowledged that the non-automated reel cradle modules 150 can be omitted from the device 100 or can be mixed with at least one automated reel cradle module 120, as shown in FIG. 1. The at least one non-automated reel cradle module 150 is mounted to the device 100 via at least one fastening member 111.

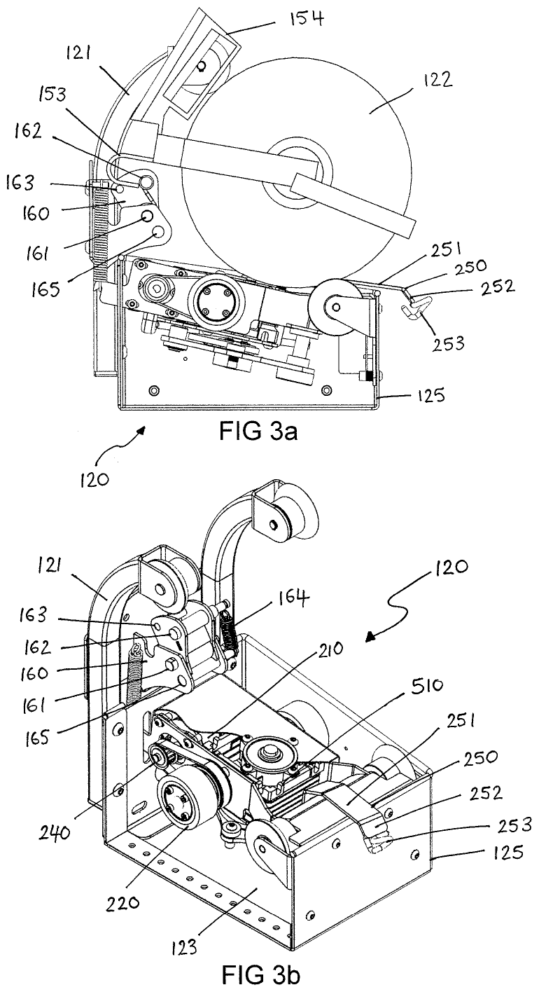

The reel cradle modules 120, 150 comprise a unique spring-loaded locking mechanism 160 that easily and securely locks the electric fence wire reel 122, 152 within the cradle 121, 151. Referring to FIGS. 3a and 3b, which shows the automated reel cradle module 120 as an example, the reel 122 has a hook 153 which enables the reel 122 to be secured to the reel cradle module 120 via the spring-loaded locking mechanism 160. The spring-loaded locking mechanism 160 comprises at least one pin including, but not limited to, a pivot pin 161, a latching/locking pin 162 and an activating pin 163. The pivot pin 161 enables the rotation of the spring-loaded locking mechanism about the pin 161. The latching/locking pin 162 is engagable with the hook 153 to lock the reel 122 in place. A spring 164 is attached at one end to the latching/locking pin 162 and at an opposing end to a limit pin 165. In the locked position, the reel 122 is able to rotate within the cradle 121. The spring-loaded locking mechanism 160 operates by the reel hook 153 pushing on an actuating rod and/or applying pressure to activation pin 163 which causes the spring-loaded locking mechanism 160 to start rotating about the pivot pin 161 in a cam-like manner. This in effect causes the latching/locking pin 162 to engage the hook 153 on the reel 122 and create a pulling/pushing (depending of direction of observation) force, locking the reel 122 within the cradle 121. The spring 164 pulls down on the hook 153 to secure the hook 153 in a locked position. The reel 122 is locked using a simple rolling motion of a reel handle 154. To unlock, one can simply reverse the action. In the locked position, the reel 122, can rotate for feeding out the fence wire.

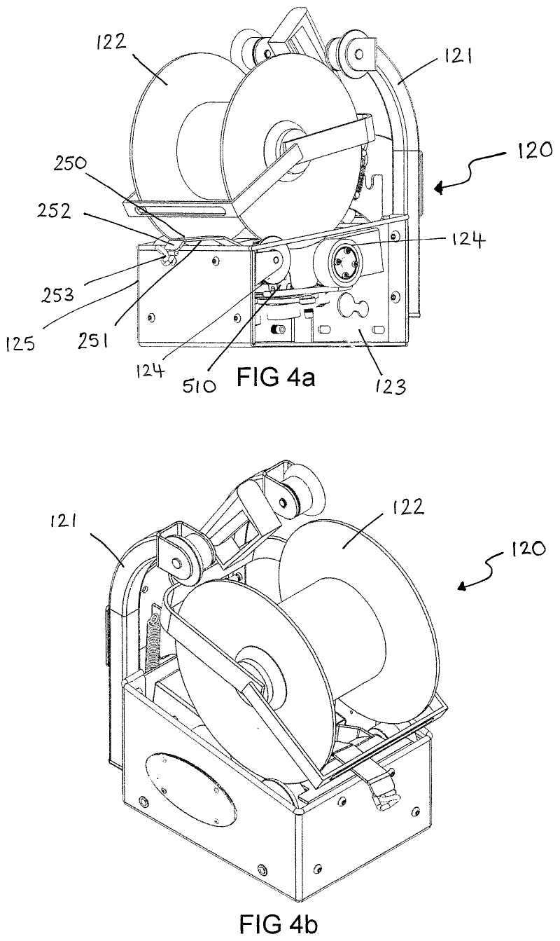

Referring to FIGS. 4a and 4b, the modular fencing storage and handling device 100 can comprise at least one automated reel cradle module 120 having a cradle 121 for the storage and handling of a fence wire reel 122 including, but not limited to, an electric fence wire reel. The fence wire reel can be any commercially available reel which can easily be retrofit into the present invention. The automated cradle module 120 is capable of functioning both as a standalone unit as well as being part of a multiple module assembly. The device 100 is designed to have one or more automated reel cradle modules 120 for storing and carrying electric fence wire reels 122 which is generally sufficient to provide enough wire for a reasonably sized temporary electric fencing application. It will be acknowledged that additional automated reel cradle modules 120 can be added to the device 100 where required, to suit larger fencing applications. The at least one automated reel cradle modules 120 is mounted to the device 100. The automated reel cradle module 120 is designed to be a single position unit wherein, once the reel 122 is secured within the automated reel cradle module 120, the fence wire can be fed off, and onto, the reel without requiring any repositioning of the reel 122 and/or cradle module 120.

As the fence wire is fed off, or onto, the reel, the torque is adjusted electronically, via a suitable electronic unit, to match the speed of the vehicle to feed the wire while maintaining constant tension to prevent potential damage occurring from overload. Feeding of the wire is adjusted via a cam arrangement on the gearbox 510. The automated reel cradle module 120 has enough internal friction to allow the fence wire to be fed off the reel 122, stopping and starting without the wire running on to cause a tangle.

Referring to FIGS. 3b, positioned within the base 123 of the automated reel cradle module 120 is a powered driving mechanism to control the automated winding of the fence wire onto the reel 122. The driving mechanism comprises a motor 210 which can be battery powered or powered by a vehicle's engine. A rubber coated drive roller 220 of the driving mechanism can be suitably mounted within the base 123 of the automated reel cradle module 120 and is driven by a pulley 240 mounted internally within the base 123. The motor 210 drives pulley 240 which in turn drives the rubber coated drive roller 220 operably connected thereto. An opposing end of the rubber coated drive roller 220 is connected through the gearbox 510. The reel 122 rests upon wheels 124 which are spring-loaded to maintain constant force on the drive wheels, as shown in FIG. 4a.

Referring to FIGS. 3a, 3b and 4a the automated reel cradle module 120 comprises a layering means 250 which allows the fence wire to be layered evenly across the reel 122 as it is being fed onto the reel 122. According to an embodiment of the present invention, the layering means 250 is in the form of a wire feed guide. The wire feed guide 250 is driven by motor 210 through gearbox 510. The wire feed guide 250 comprises a guide arm 251 having a first end 252 which protrudes outwardly from a front end 125 of the base 123 of the automated reel cradle module 120. Provided at the first end 252 of the guide arm 251 of the wire feed guide 250 is a retaining means 253 in the form of a loop for receiving the fence wire and allowing it to be held and fed therethrough onto the fence reel 122 via the wire feed guide 250. The wire feed guide 250 moves horizontally back and forth to ensure the fence wire is evenly fed across the reel 122 to layer the wire and prevent it being tangled as it is loaded onto and/or unloaded from the reel 122.

A unique spring-loaded locking mechanism can be provided that easily and securely locks the electric fence wire reel within the cradle. It is envisaged that a spring-loaded locking mechanism can be provided on any module to securely store components, tooling and/or accessories in place. It will also be acknowledged that a spring-loaded locking mechanism can be adapted to secure one or more modules to the device.

Referring to FIGS. 1 and 2, the improved modular fencing storage and handling device 100 can further comprise a toolbox module 130 for storage requirements for fence tooling and accessories. The toolbox module 130 comprises a rectangular toolbox 131 mounted to a base 110 which can be secured to one or more other modules. However, it is envisaged that any other suitable style or shape of toolbox 131 or storage compartment may also be adopted. The toolbox 131 has a lid 133 hingedly connected to the toolbox 131 along one side to provide a waterproof toolbox for portable battery powered fence unit storage. It is envisaged that the lid 133 may also be lockable for the storage and protection of expensive tooling and/or accessories.

Referring to FIG. 2, the modular fencing storage and handling device 100 can further comprise a post rack module 140 having at least one detachable post carrying rack 141 which is adapted to be removably connected to a base 148 of the module 140, wherein the base 148 can be connected to one or more other modules 120, 130, 150 of the device 100. The post rack module 140 is designed to store enough posts 173 for the average fencing application and can accommodate various types of brands, shapes and sizes of temporary fence posts. It will be acknowledged that additional post rack modules 140 and/or post carrying racks 141 can be provided where necessary. Furthermore, where the toolbox 131 is not required and/or additional reel storage is necessary, it is envisaged that the toolbox module 130 can be replaced with a further reel cradle module 120, 150.

The post rack module 140 comprises at least one detachable post carrying rack 141 and a pair of upright bracket members 142. The bracket members 142 are mounted to a base 148 of the post rack module 140 at a bottom end and connected together at the top end by bracket 170 via at least one fastening member 143 such as a bolt or the like. The post carrying rack 141 comprises a pair of u-shaped holding arms 145 spaced apart from each other by a pair of horizontal bars 144. The u-shaped holding arms 145 are adapted to receive and securely support an end of at least one post 173 therein. The u-shaped holding arms 145 comprise a support bar 146 which is slidably movable in a vertical direction along the u-shaped holding arms 145 to secure and/or raise and lower the posts stored therein. A pair of tabs 149 are provided on the base 148 of the post rack module 140 to secure a bottom horizontal bar of the post carrying rack 141 against the bracket members 142 and prevent the post carrying rack 141 from slipping forward. A clip 147 is provided on bracket 170 to secure the top horizontal bar 144 of the post carrying rack 141. In an alternative embodiment, it is envisaged that at least one lock in the form of a clamp-like device may be provided which clips the post carrying rack 141 to hold it securely in place. A carry handle 171 is provided at the top of the post carrying rack(s) 141 for portable hand-held operations. It is envisaged that one or more of the post carrying racks 141 can be swapped for a utility tool holder or removed when not in use or not required.

In a further embodiment, the device can have at least one light bar which can be positioned on the toolbox module or any other suitable position of the device to enable visibility at night or in low-light conditions. The light bar could be in the form of a light-emitting diode (LED) light bar which is connected to a suitable power supply, such as battery or vehicle power supply.

Hence, the present provides a solution to the aforementioned problems of the prior art by providing a modular fencing storage and handling device for electric fencing which provides storage for temporary fence posts, portable electric fence wire reels and other fencing components. The present invention can advantageously be used with any commercially available fencing wire reel which can be easily retrofit into the reel module, unlike existing products which require a proprietary reel. The present invention provides a safer, easier and more efficient way to reel out and retrieve portable electric fence wire (reels) and also prevents damage to the electric fence reels. The modules can be added or removed with ease as required to suit different applications and/or vehicles.

The reference to any prior art in this specification is and should not be taken as, an acknowledgment or any form or suggestion that the prior art forms part of the common general knowledge in any country.

Throughout the specification the aim has been to describe the invention without limiting the invention to any one embodiment or specific collection of features. Persons skilled in the relevant art may realize variations from the specific embodiments that will nonetheless fall within the scope of the invention.

1. A modular fencing storage and handling device, comprising:
at least one interchangeable automated reel cradle module comprising:
a cradle for the storage and handling of a fence wire reel;
a powered driving mechanism to control the automated winding of a fence wire onto the fence wire reel; and
means for layering for allowing the fence wire to be layered evenly across the fence wire reel as it is being fed onto the fence wire reel.

2. (canceled)

3. The modular fencing storage and handling device of claim 1, wherein the driving mechanism comprises a motor.

4. The modular fencing storage and handling device of claim 1, wherein the driving mechanism includes one or more rubber coated drive rollers mounted within a base of the automated reel cradle module and are driven by a pulley.

5. The modular fencing storage and handling device of claim 1, wherein torque is controlled electronically to prevent potential damage occurring from overload.

6. The modular fencing storage and handling device of claim 1, wherein the means for layering is a wire feed guide.

7. The modular fencing storage and handling device of claim 6, wherein the wire feed guide is driven by a motor through a gearbox within the base of the automated reel cradle module.

8. The modular fencing storage and handling device of claim 6, wherein the wire feed guide comprises a guide arm having a guide arm and retaining means in the form of a loop or guide for receiving the fence wire and allowing the fence wire to be held and fed therethrough onto the fence reel via the wire feed guide.

9. The modular fencing storage and handling device of claim 1, further comprising at least one interchangeable storage module removably connected thereto to store a fencing component for an installation of fencing including at least one of an automated reel cradle module, a non-automated reel cradle module, a toolbox module and a post rack module.

10. An automated reel cradle module for use with a fencing storage and handling device, comprising:
a cradle for the storage and handling of a fence wire reel;
a powered driving mechanism to control the automated winding of a fence wire onto the fence wire reel; and
means for layering for allowing the fence wire to be layered evenly across the fence wire reel as it is being fed onto the fence wire reel.

11. (canceled)

12. The modular fencing storage and handling device of claim 10, wherein the driving mechanism comprises a motor.

13. The modular fencing storage and handling device of claim 10, wherein the driving mechanism includes one or more rubber coated drive rollers mounted within a base of the automated reel cradle module and are driven by a pulley.

14. The modular fencing storage and handling device of claim 10, wherein torque is controlled electronically to prevent damage from overload.

15. The modular fencing storage and handling device of claim 10, wherein the means for layering is a wire feed guide.

16. The modular fencing storage and handling device of claim 15, wherein the wire feed guide is driven by a motor through a gearbox within the base of the automated reel cradle module.

17. The modular fencing storage and handling device of claim 15, wherein the wire feed guide comprises a guide arm having a guide arm and retaining means in the form of a loop or guide for receiving the fence wire and allowing the fence wire to be held and fed therethrough onto the fence reel via the wire feed guide.
